(19) United States
(12) Patent Application Publication
(10) Pub. No.: US 2014/0063602 A1
(43) Pub. Date: Mar. 6, 2014

(54) Pixel Structure And Display Device

(71) Applicant: BOE Technology Group Co., Ltd., Beijing (CN)

(72) Inventor: Yangbing Wu, Beijing (CN)

(73) Assignee: BOE Technology Group Co., Ltd., Beijing (CN)

(21) Appl. No.: 13/995,947

(22) PCT Filed: Jan. 6, 2013
(86) PCT No.: PCT/CN2013/070103

§ 371 Date: Jun. 19, 2013

(30) Foreign Application Priority Data
Feb. 29, 2012 (CN) 201220072126.6

(51) Int. Cl. G02B 27/22

(52) U.S. Cl. CPC G02B 27/225; G02B 27/2214
USPC 359/464

(57) ABSTRACT

Embodiments of the present invention disclose a pixel structure and a display device concerning to the technical field of 3D display. In this pixel structure, the distance of the center points of the transmitting regions of any two adjacent sub-pixels in each row is equal to the distance of the center points of the transmitting regions of the any two adjacent sub-pixels in each column. The pixel structure and the display device decrease the costs of the display device, and also a better 3D effect in the horizontal and vertical directions can be achieved at the same viewing distance without parallax barriers placed at two different heights.

### BACKGROUND

Embodiments of the present invention relate to a pixel structure and a display device.

With the development of display techniques and the people's increasing demand for sensation, 3D display techniques have drawing attentions broadly since 2010. One of the principles to achieve 3D display is to produce three-dimension effect by means of parallax, that is, a user's left eye watches left eye pictures while right eye watches right eye pictures, then a three-dimensional vision is formed in the human brain. A left eye picture and a right eye picture constitute a pair of three-dimensional pictures having parallax.

The current 3D display techniques are primarily divided into spectacle techniques and naked-eye techniques. With a spectacle technique, it's inevitable that a user has to wear spectacles and thus long-duration watching will result in eyestrain and depress the watching easiness. In contrast, naked-eye 3D techniques certainly will be the developing trend for future 3D display techniques, and the techniques for improving display panels will be the highlight of the naked-eye 3D technique.

Parallax barrier methods are common techniques for naked-eye 3D display. As shown in FIG. 1, each naked-eye 3D display device applying a parallax barrier method comprises a display unit 1 and its corresponding parallax barrier 2. The display principle thereof is as follows: the pixels indicated with leftward-slanted stripes present left eye pictures, and the pixels indicated with rightward-slanted stripes present right eye picture, the parallax barrier 2 is placed in front of the display unit 1, and the light-shielding region of the parallax barrier 2 (the black line segments shown in the drawing) can shield the right eye picture from the left eye of the viewer and shield the left eye picture from the right eye, and correspondingly, through the transmitting region (the portion between two black line segments in the drawing), the viewer's left eye can only watches the left eye picture and the right eye can only watches the right eye picture, thus obtaining a 3D effect.

When the parallax barrier 2 and the display unit 1 are placed at a certain height, the width of the sub-pixel on the display unit 1 determines the optimal watch distance. As shown in FIG. 2, the principle for obtaining optimal watch distance is as follows. Given the interocular distance A and a placement height H are predetermined, it can be derived that, according to homothetic triangle principle:

$$\frac{L}{H} = \frac{A}{B}$$

$$L = \frac{A \times H}{B}$$

Usually, the widths of various sub-pixel are the same, and the widths of the black matrices one both sides of each sub-pixel are also the same, and therefore the light point (which is simplified as the middle point of the transmitting region over the sub-pixel) distance B equals the width P of a sub-pixel. It can be concluded that, when the interocular distance A and the placement height H are determined, the width of the sub-pixel is inversely proportional to the optimal watch distance.

The traditional pixel structures are as shown in FIGS. 3(a) and (b); FIG. 3 (a) shows a traditional three-primary-colors pixel structure, FIG. 3 (b) shows a traditional four-primary-colors pixel structure. Regardless of any kind of structure, the sub-pixels thereof are each in a rectangle shape, that is, the long side does not equal to the short side thereof.

As to a cell phone and a table PC, users often watch the screen both in the horizontal and vertical directions. Thus 3D display needs to be achieved in both directions. However, the shape of the existing sub-pixel makes that, if one parallax barrier is used and does not change in its placement height, the optimal watch distances are different for the horizontal placement and vertical placement situations. One of the methods for addressing such a problem is to place two parallax barriers in order in front of the display panel, thus providing parallax barriers at two placement heights so as to make the optimal watch distances consistent in both directions, which however undoubtedly greatly increases costs.

### SUMMARY

Embodiments of the present invention provides a pixel structure and a display device capable of realizing a better 3D effect at a same watch distance in both the horizontal and vertical directions while having relatively low costs.

One aspect of the present invention provides a pixel structure comprising sub-pixels arranged in rows and columns, wherein a distance of center points of transmitting regions of any two adjacent sub-pixels in each row is equal to a distance of center points of transmitting regions of any two adjacent sub-pixels in each column.

For example, the pixel structure may be a three-primary-colors pixel structure.

For example, each sub-pixel in the three-primary-colors pixel structure is in a square shape of a same size.

For example, each sub-pixel in the three-primary-colors pixel structure is in a rectangle shape of a same size, and all sub-pixels are arranged in a same manner.

For example, the sub-pixels in each column are arranged to be spaced from each other by a first predetermined distance, and any two adjacent sub-pixels in each row are arranged to be spaced from each other by a second predetermined distance.

For example, the pixel structure may be a four-primary-colors pixel structure.

For example, each sub-pixel in the four-primary-colors pixel structure is in a square shape of a same size, and every two adjacent sub-pixels in the same row constitute one sub-pixel group, and adjacent two sub-pixel groups arranged in one column constitute one pixel unit, four sub-pixels of each of any two pixel units in the same column are identical in their arrangement, and as to the pixel units in the same row, any two adjacent pixel units are arranged in a centrally symmetrical way to each other.

Another aspect of the present invention provides a display device comprising the above pixel structure.

For example, the device may further comprise a parallax barrier corresponding to the pixel structure.

For example, the parallax barrier may be transformed to be wholly transparent, or transformed to only present light shielding strips extending in parallel to each other in the horizontal or vertical direction of the parallax barrier, or transformed to present light shielding strips perpendicular to each other in both the horizontal and vertical directions of the parallax barrier.

The pixel structure and display device of the embodiments of the present invention can achieve a better 3D effect at a same watch distance in both the horizontal and vertical directions and reduce the cost of the display device, without two parallax barriers placed at two different placement heights being provided.

### BRIEF DESCRIPTION OF THE DRAWINGS

In order to illustrate the technical solution of the embodiment of the present invention more clearly, a simply introduction about the drawings of the embodiments will be made in the following, and obviously, the drawings described later relate to only some embodiments of the present invention, rather than limitation to the present invention.

FIG. 1 is a schematic view of the structure and display principle of a traditional display device;

FIG. 2 is a diagram showing the light paths of the display device as shown in FIG. 1;

FIG. 3(a) shows a traditional three-primary-colors pixel configuration;

FIG. 3(b) shows a traditional four-primary-colors pixel configuration;

FIGS. 4 to 8 show the schematic views of the pixel structure according to embodiments of the present invention; and

FIG. 9 shows a structural schematic view of the parallax barrier of the display device according to an embodiment of the present invention.

### DETAILED DESCRIPTION

To make clearer the object, technical solutions and advantages of the embodiments of the present invention, a clear and full description of the technical solution of the embodiment of the present invention will be made with reference to the accompanying drawings of the embodiment of the present invention. Obviously, the described embodiments are merely part of the embodiments of the present invention, but not all the embodiments. Based on the described embodiments of the present invention, all the other embodiments acquired by the ordinary skilled in this art, without any creative labor, fall into the protective scope of the present invention.

Unless otherwise defined, the technical or scientific terms used herein should have common meanings to be understood by the ordinary skilled in this art of the present invention. Phrases “first”, “second” as well as similar words used in the patent application specification and claims of the present invention do not mean any sequence, quantity or importance, but are only used to distinguish different components. Similarly, phrases such as “a”, “an”, “the” and the like do not mean quantitative restriction, but mean the existence of at least one object. The phrases “comprise” or “contain” and the like intend to mean that the elements or articles before the phrases encompass the elements or articles and the equivalent thereof listed after the phrases, and do not exclude other elements or articles. Phrases such as “connected to” or “coupled with” are not limited to physically or mechanically connection, but include electrically connection, no matter direct or indirect. Further, phrases “upper”, “lower”, “left”, “right” etc are used only for describing a relative positional relationship, which will be varied correspondingly when the described objects are changed in the absolute positions.

For the purpose of realizing a better 3D effect at a same watch distance in both the horizontal (row) and vertical (column) directions, in the pixel structure according to one embodiment of the present invention, the distance between the center points of the transmitting regions of any two adjacent sub-pixels in each row is equal to the distance between the center points of the transmitting regions of any two adjacent sub-pixels in each column.

In the pixel structure of the embodiment of the present invention, the pixel structure may be a three-primary-colors pixel structure (one pixel structure comprises three sub-pixels, for example, red-green-blue (RGB)) or a four-primary-colors pixel structure (one pixel structure comprises four sub-pixels, for example, red-green-blue-yellow (RGBY) or red-green-blue-white (RGBW)).

When the pixel structure is a three-primary-colors pixel structure, each sub-pixel may be in a square shape, and also may be in a traditional rectangle shape, the aspect ratio of which can be determined according to a certain condition.

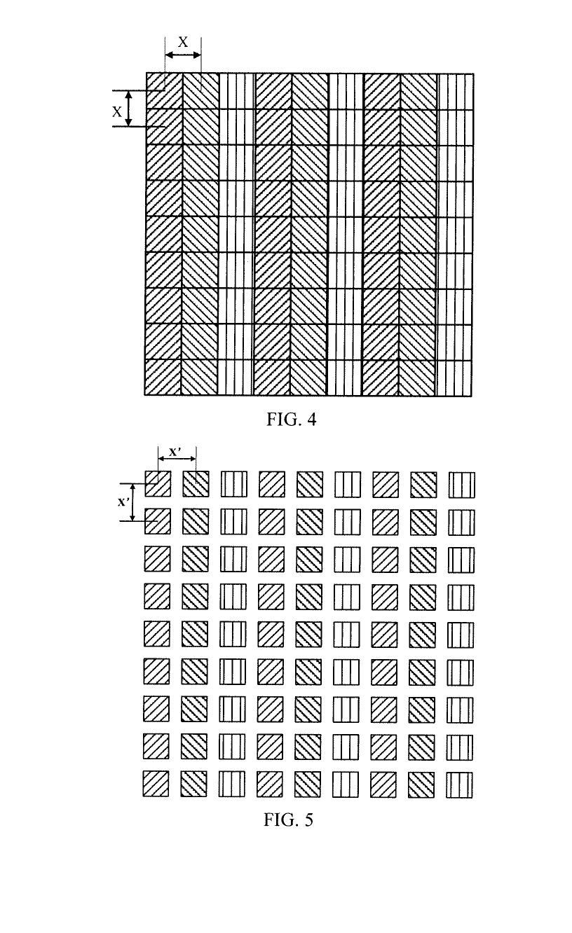

As shown in FIG. 4, the sub-pixel in the pixel structure of this example is in a square shape of a same size, and the interval between any adjacent sub-pixels is zero, and accordingly the distance between the center points of the transmitting regions of any two adjacent sub-pixels in each row equals to the distance between the center points of the transmitting regions of any two adjacent sub-pixels in each column, that is, both are X.

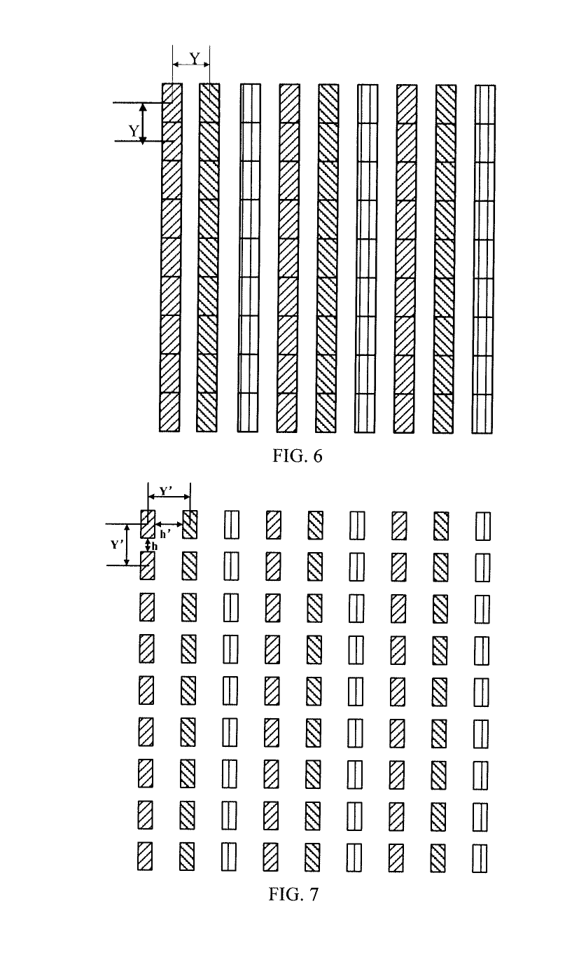

As shown in FIG. 5, the sub-pixels in the pixel structure of this example are squares of the same size, but differing from FIG. 4, each two sub-pixels are arranged with a same distance therebetween. The distance of the center points of the transmitting regions of any two adjacent sub-pixels in each row equals to the distance of the center points of the transmitting regions of any two adjacent sub-pixels in each column, and both are X′. As shown in FIGS. 6 to 7, sub-pixels in the pixel structure of both examples are rectangles of a same size, and further all sub-pixels are identical in their arrangement manner. In the sub-pixel structure as shown in FIG. 6, the sub-pixels in each column are arranged to be closely adjacent to each other, and the sub-pixels in each row are arranged to be spaced from each other by a predetermined distance; such a predetermined distance makes that the distance between the center points of the transmitting regions of any two adjacent sub-pixels in each row equals to the distance between the center points of emitting zones of any two adjacent sub-pixels in each column, and both are Y. In the sub-pixel structure as shown in FIG. 7, the sub-pixels in each column are arranged to be spaced from each other by a first predetermined distance, the sub-pixels in each row are arranged to be spaced from each other by a second predetermined distance, and in order to make that the distance between the center points of the transmitting regions of any two adjacent sub-pixels in each row equals to the distance between the center points of emitting zones of any two adjacent sub-pixels in each column, i.e., both are Y′, the first predetermined distance h is less than the second predetermined distance h′.

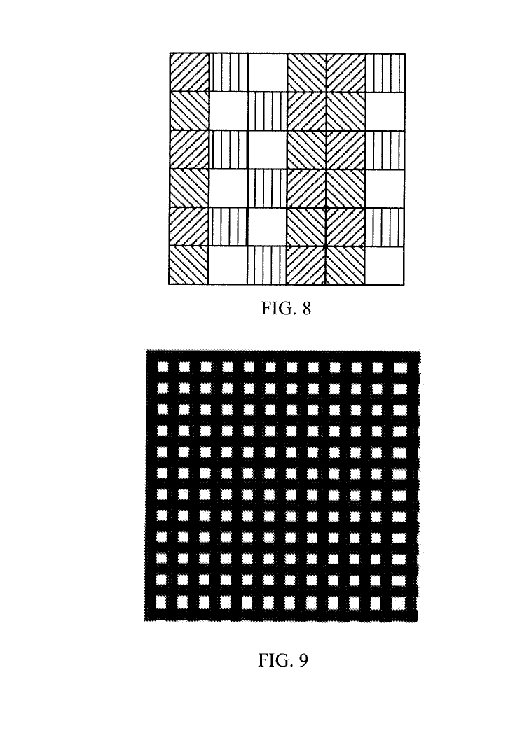

When the pixel structure is a four-primary-colors pixel structure, as shown in FIG. 8, each sub-pixel of this example may be in a square shape of a same size, every two adjacent sub-pixels in the same row constitute one sub-pixel group, every adjacent two sub-pixel groups arranged in one column constitute one pixel unit, and four sub-pixels in each of any two pixel units in the same column are identical in their arrangement manner. For achieving normal display, any adjacent two pixel units in the same row are arranged in a centrally symmetrical way to each other.

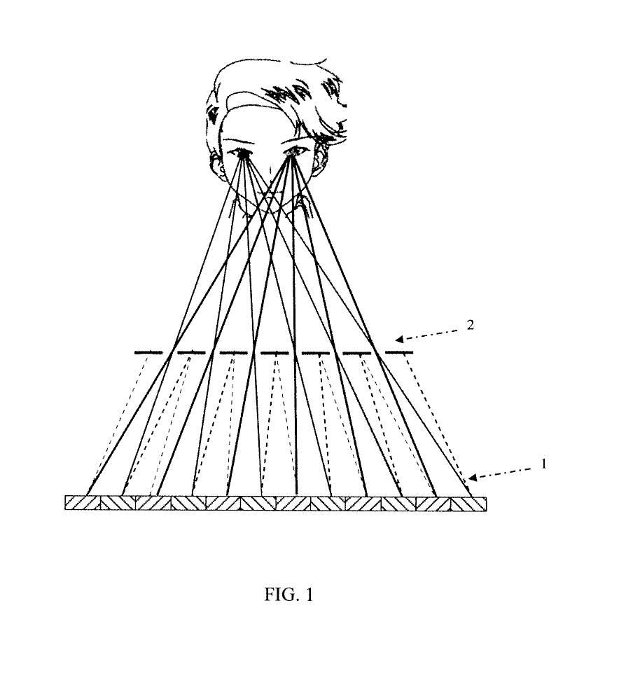

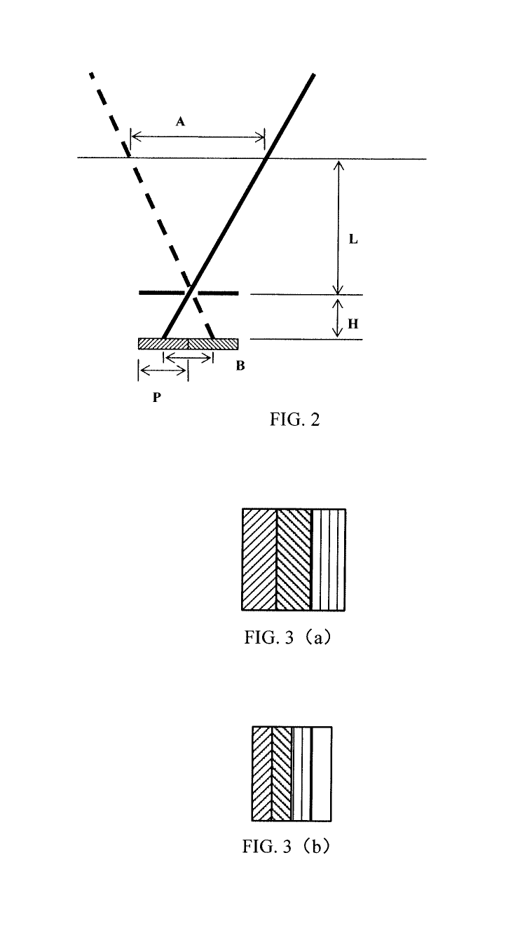

Another embodiment of the present invention further provides a display device comprising any one of the above pixel structures as well as the parallax barrier corresponding thereto. Where each sub-pixel is in a square shape, the parallax barrier corresponding thereto is shown in FIG. 9. The parallax barrier is provided in front of the display panel having the above pixel structure, facing toward a user, as shown for example in FIG. 1. The display panel may be any suitable display panel in the relevant art, for example, a liquid crystal display panel, an organic illuminant display panel, a plasma display panel, etc.

In the display device of the embodiment of the present invention, the parallax barrier may take the manner of light shielding strips and is unchangeable, that is, the display device of the embodiment of the present invention achieves 3D display function only. The parallax barrier may also take the manner of light shielding strips but is changeable, that is, the parallax barrier may be transformed to be wholly transparent, and in this case, 2D display can be achieved; or the parallax barrier may be transformed to light shielding strips extending in parallel in a same direction (the horizontal or vertical direction of the parallax barrier), for example, when the viewer watches 3D effect in the first direction (where the display device having the parallax barrier shown in FIG. 9 is provided, watching in the first direction means that the connecting line between two eyes of the viewer is perpendicular to the vertical (column) direction of the parallax barrier), light shielding strips arranged to be extending in parallel in the first direction (vertical) are presented, and when the viewer watches 3D effect in the second direction, which is perpendicular to the first direction, (still where the display device having the parallax barrier shown in FIG. 9 is provided, watching in the second direction means that the connecting line between two eyes of the viewer is perpendicular to the horizontal (row) direction of the parallax barrier), light shielding strips arranged to be extending in parallel in the second direction (vertical) are presented; or the parallax barrier may be transformed into such a case where light shielding strips are presented extending in two directions perpendicular to each other (the horizontal and vertical directions of the parallax barrier).The parallax barrier comprises light holes arranged in rows and columns, and the distances between the centers of each two light holes in each row and each column could equal to each other.

It should be noted that, in the display device of the embodiment of the present invention, the number of the sub-pixels included in each pixel structure and the specific shape of each sub-pixel are not limitative to the above described embodiments.

The foregoing are merely exemplary embodiments of the invention, but are not used to limit the protection scope of the invention. The protection scope of the invention is defined by attached claims.

1. A pixel structure, comprising sub-pixels arranged in rows and columns, wherein a distance between center points of transmitting regions of any two adjacent sub-pixels in each row is equal to a distance between center points of transmitting regions of any two adjacent sub-pixels in each column.

2. The pixel structure according to claim 1, wherein the pixel structure is a three-primary-colors pixel structure.

3. The pixel structure according to claim 2, wherein each sub-pixel in the three-primary-colors pixel structure is in a square shape of a same size.

4. The pixel structure according to claim 2, wherein each sub-pixel in the three-primary-colors pixel structure is in a rectangle shape of a same size, and all the sub-pixels are arranged in a same way.

5. The pixel structure according to claim 4, wherein any two adjacent sub-pixels in each column are arranged to be spaced from each other by a first predetermined distance, and any two adjacent sub-pixels in each row are arranged to be spaced from each other by a second predetermined distance.

6. The pixel structure according to claim 1, wherein the pixel structure is a four-primary-colors pixel structure.

7. The pixel structure according to claim 6, wherein each sub-pixel in the four-primary-colors pixel structure is in a square shape of a same size, and every two adjacent sub-pixels in a same row constitute one sub-pixel group, adjacent two sub-pixel groups arranged in one column constitute one pixel unit, and four sub-pixels in each of any two pixel units in a same column are identical in their arrangement, while in the pixel units in a same row, any two adjacent pixel units are arranged in a centrally symmetrical way to each other.

8. A display device comprising the pixel structure according to claim 1.

9. The display device according to claim 8, further comprising a parallax barrier corresponding to the pixel structure.

10. The display device according to claim 9, wherein the parallax barrier is capable of being transformed to be wholly transparent, or transformed to only present the light shielding strips extending in parallel in the horizontal or vertical direction of the parallax barrier, or transformed to present light shielding strips extending in parallel in the horizontal and vertical direction of the parallax barrier simultaneously.
